(19) United States
(12) Patent Application Publication
(10) Pub. No.: US 2012/0045739 A1
(43) Pub. Date: Feb. 23, 2012

(54) ORAL HYGIENE TOOL

(76) Inventor: DARLA SCHMIDT, Deerfield, MI (US)

(21) Appl. No.: 12/861,027

(22) Filed: Aug. 23, 2010

(51) Int. Cl. A61C 15/00

(52) U.S. Cl. 433/216

(57) ABSTRACT

An oral hygiene tool comprising a wand extending from an end to an attachment end, an absorbent swab connected to the wand at the attachment end; where the absorbent swab collects a layer of saliva within a mouth of a person, a textured bottom of the absorbent swab, a domed top connected to an opposite portion of the absorbent swab form the textured bottom, wherein the domed top and the textured bottom of the absorbent swab collect the layer of saliva while the wand moves the absorbent swab over a plurality of surfaces to clean within the mouth.

### BACKGROUND OF THE INVENTION

1. Field of the Invention

The present invention relates to an oral hygiene device that enables a user to extract excess saliva and bacteria from a mouth and leaves the mouth feeling clean and refreshed.

2. Description of Related Art

Most people have daily cleansing routines that they consistently perform to ensure that their bodies stay clean and healthy. Oral hygiene is one of the major parts of these daily cleansing routines. Dentists recommend that individuals should brush their teeth twice a day, floss once a day and visit the dental office every six months to maintain proper oral care. Many advances have been made from the basic toothbrushes, yet a simple toothbrush and floss is all one really needs. With the wide variety of toothbrushes, flossing devices, waterpicks and oral rinses many people are able to keep up with caring for their teeth which leaves them clean and healthy.

Unfortunately, not everyone is able to care for their teeth or even mouths every day. Those individuals who may be bed ridden or with physical disabilities may not have the physical mobility to maintain their teeth, mouth or breath. For these people often times saliva and bacteria builds causing tooth decay, bad breath and overall poor oral hygiene. The caretakers often try to give the person oral rinses, mints or other breath fresheners to help improve the breath but these methods are ineffective and poor substitutes to good oral care. Still other caretakers may try brushing their patients teeth but since the people are unable to spit the saliva may spill from the mouth and pool on the patients face or clothing.

It would be desirable in the art to provide an oral cleansing tool which would enable a caretaker to easily clean and refresh the mouth of their patients. It would also be beneficial to have a tool which extracts the excess saliva and bacteria left in the mouth of a person with physical disabilities.

### SUMMARY OF THE INVENTION

In view of the foregoing disadvantages inherent in the prior art, the general purpose of the present disclosure is to provide an oral hygiene tool to be used by caregivers and the like to better maintain the oral care of their patients who may be unable to clean their own mouths due to physical disabilities or other similar conditions.

Accordingly, the present invention relates to an oral hygiene tool comprising a wand extending from an end to an attachment end, an absorbent swab connected to the wand at the attachment end; where the absorbent swab collects a layer of saliva within a mouth of a person, a textured bottom of the absorbent swab, a domed top connected to an opposite portion of the absorbent swab form the textured bottom, wherein the domed top and the textured bottom of the absorbent swab collect the layer of saliva while the wand moves the absorbent swab over a plurality of surfaces to clean within the mouth.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of an oral hygiene tool in accordance with an exemplary embodiment of the present invention;

FIG. 2 depicts a bottom view of an oral hygiene tool in accordance with an exemplary embodiment of the present invention; and

FIG. 3 depicts a top view of an oral hygiene tool in accordance with an exemplary embodiment of the present invention.

Like reference numerals refer to like parts throughout the description of several views of the drawings.

### DETAILED DESCRIPTION OF THE DRAWINGS

The present invention discloses an oral hygiene tool as a way to provide an oral care system for individual who may be bed ridden or incapacitated either due to sedation, mental disabilities, physical disabilities or people who cannot care for themselves. The oral hygiene tool offers those individuals a way for another person to clean their mouth to leave their mouth and breath fresh and clean. The oral hygiene tool may reach all areas of the person's mouth with ease and simplicity. By gently cleaning and absorbing mucus and excess saliva, caregivers can easily provide oral hygiene care to others without challenges or difficulties normally posed when mints or breath fresheners are provided. The oral hygiene tools may ensure proper dental care practices in hospitals, nursing home or any other desired location.

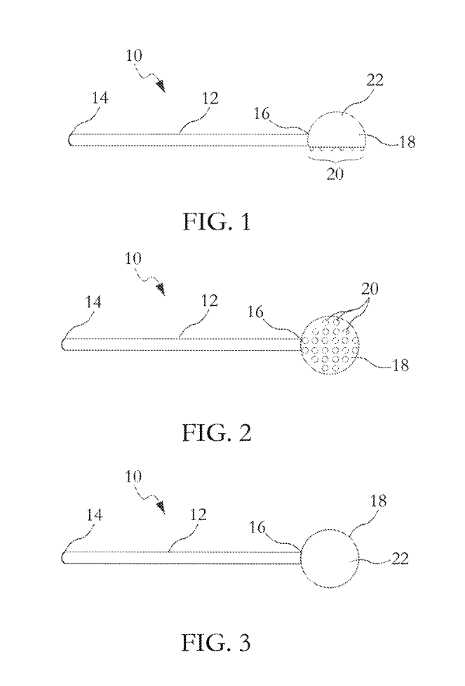

Turning now descriptively to the drawings, referring to FIG. 1, a perspective view of an oral hygiene tool (10) is shown in accordance with an exemplary embodiment of the present invention. The oral hygiene tool (10) may comprise a wand (12) and an absorbent swab (18). The wand (12) serves as a handle or gripping portion for the oral hygiene tool (10), and enables a user or caretaker to grasp the tool during use. The wand (12) includes two ends, an end (14) distally located from where the absorbent swab (18) attaches to the wand (12) and an attachment end (16) which connects the wand (12) to the absorbent swab (18). The length of the wand (12) may be six inches or greater to enable the user to maneuver the oral hygiene tool (10) without their fingers having to enter the mouth of their patient. The wand (12) may be a tube, a flat stick or an ergonomic piece for easy handling by the user, and may be made from plastic, paper, wood or another similarly used material desired by the inventor.

The absorbent swab (18) may comprise a domed top (22) and textured bottom with a plurality of cleaning nubs (20). The domed top (22) may help the user to swipe and clean a roof of the mouth. The roof of the mouth is covered with a delicate and textured layer of skin thus the domed top (22) must be gentile enough to rub the roof of the mouth without damaging the skin. The textured bottom of the absorbent swab (18) may be covered with a plurality of cleaning nubs (20) (hereinafter cleaning nubs) which rub and scrape over a plurality of surfaces within the mouth. The plurality of surfaces may be the tongue, gums, cheeks, teeth and the like. The absorbent swab (18) and the cleaning nubs (20) may be comprised of a water or moisture absorbing sponge, cloth or similar material to wick the excess saliva and moisture from a person's mouth. The material comprising the absorbent swab (18) may start hard or rigid and then as a layer of saliva is removed or water is absorbed the material softens to extract the excess moisture. The absorbent swab (18) may have a circular or oval shape to comfortably move within the person's mouth. The oral hygiene tool (10) may better enable those individuals who may be incapacitated or with poor physical abilities to have a clean mouth when assisted by the user.

Referring to FIG. 2, a bottom view of the oral hygiene tool (10) is shown in accordance with an exemplary embodiment of the present invention. The wand (12), end (14) and attachment end (16) are all illustrated similar as to FIG. 1. The cleaning nubs (20) are better seen in FIG. 2. The cleaning nubs (20) may be spaced close together and in a random pattern depending on the preferences of the user. Finally, the textured bottom and the cleaning nubs (20) may be covered by a flavored layer or coating. The flavored layer may be a mint, fruit, spice or another pleasant tasting flavor as desired by the user so that the person's mouth is left tasting good.

Referring to FIG. 3, a top view of the oral hygiene tool (10) is shown in accordance with an exemplary embodiment of the present invention. The domed top (22) may have a generally smooth surface to wipe against the person's roof of their mouth. Also, the flavored layer may cover the domed top (22) along with the textured bottom to leave the entire mouth feeling refreshed and tasting pleasant. Accordingly, after the oral hygiene tool (10) is wiped in the mouth by moving the wand (12) the absorbent swab (18) extracts the excess saliva, thus leaving the mouth feeling fresh, clean and tasting pleasant.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An oral hygiene tool comprising:
a wand extending from an end to an attachment end;
an absorbent swab connected to said wand at said attachment end; where said absorbent swab collects a layer of saliva within a mouth of a person;
a textured bottom of said absorbent swab;
a domed top connected to an opposite portion of said absorbent swab form said textured bottom, wherein said domed top and said textured bottom of said absorbent swab collect said layer of saliva while said wand moves said absorbent swab over a plurality of surfaces to clean within said mouth.

2. The oral hygiene tool of claim 1, wherein said textured bottom includes a plurality of nubs to rub against and clean said plurality of surfaces within said mouth.

3. The oral hygiene tool of claim 1, wherein said textured bottom, said domed top and said plurality of nubs are covered with a flavored layer.

4. The oral hygiene tool of claim 3, wherein said flavored layer is mint to leave said mouth of said person feeling clean and refreshed.

5. The oral hygiene tool of claim 1, wherein said absorbent swab is initially rigid and then softens as said layer of saliva is absorbed.
